(19) United States
(12) Patent Application Publication
(10) Pub. No.: US 2016/0104143 A1
(43) Pub. Date: Apr. 14, 2016

(54) RECORDING DEVICE, TRANSACTION PROCESSING SYSTEM, AND CONTROL METHOD OF A RECORDING DEVICE

(71) Applicant: Seiko Epson Corporation, Tokyo (JP)

(72) Inventors: Yuichi SUGIYAMA, Matsumoto-shi (JP); Koji NISHIZAWA, Shiojiri-shi (JP); Shigeru HIRAI, Aoki-mura (JP)

(73) Assignee: Seiko Epson Corporation, Tokyo (JP)

(21) Appl. No.: 14/857,597

(22) Filed: Sep. 17, 2015

(30) Foreign Application Priority Data
Oct. 10, 2014 (JP) 2014-208782

(51) Int. Cl. G06Q 20/20; G06F 3/12

(52) U.S. Cl. CPC G06Q 20/209; G06F 3/1243; G06F 3/1205; G06F 3/1285

(57) ABSTRACT

The recording device 12 of a transaction processing system 1 receives partial receipt print data from a POS terminal 13, and based on the received partial receipt print data, controls the recording device recording unit 31 to produce a partial receipt printed with a subcode containing the partial receipt ID and the URL of a control server 15.

Priority is claimed under 35 U.S.C. §119 to Japanese Application no. 2014-208782 filed on Oct. 10, 2014 which is hereby incorporated by reference in their entirety.

### BACKGROUND

1. Technical Field

The present disclosure relates to a recording device, a transaction processing system, and a control method of a recording device.

2. Related Art

The cost of purchases made in stores and particularly restaurants, for example, is sometimes split between multiple persons with each person paying a portion of the bill. Technology related to producing receipts for each payer when the bill is shared is disclosed in JP-A-H9-330480, for example.

When a transaction payment is split between persons, providing a service based on the split payment individually to each customer in the transaction can help improve customer satisfaction.

### SUMMARY

A recording device, a transaction processing system, and a control method of a recording device according to the disclosure enable executing processes based on payment for a single transaction being split between multiple persons.

A recording device according to the disclosure includes: a recording unit that records on recording media; a communication unit that receives data for the recording unit to print; and a control unit that causes the communication unit to receive partial receipt print data containing a partial receipt ID identifying a partial receipt, which is a receipt issued when a transaction is split between multiple persons, and causes the recording unit to produce a partial receipt on which a code containing the partial receipt ID is recorded based on the partial receipt print data the communication unit received.

Thus comprised, the disclosure can execute a process appropriate to multiple persons splitting a single bill.

In a recording device according to another aspect of the disclosure, the communication unit causes the recording unit to produce a partial receipt on which a code containing the partial receipt ID and the address of an external device is recorded.

Thus comprised, a device that reads the code can be controlled to access an external device and cause the external device to execute a specific process.

Another aspect of the disclosure is a transaction processing system including: a POS terminal; a recording device that communicates with the POS terminal and has a recording unit that records on recording media; and a control server that connects to the recording device through a network. The POS terminal generates and sends partial receipt print data to the recording device. The partial receipt print data instructs producing a partial receipt, which is a receipt issued when a transaction is split between multiple persons, and contains a partial receipt ID identifying the partial receipt. The recording device receives the partial receipt print data from the POS terminal, causes the recording unit to produce a partial receipt on which a code containing the partial receipt ID and the address of the control server is recorded based on the received partial receipt print data, and sends the partial receipt print data to the control server. The control server stores information based on the partial receipt print data received from the recording device relationally to the partial receipt ID contained in the partial receipt print data.

Thus comprised, the disclosure can execute a process appropriate to multiple persons splitting a single bill.

A transaction processing system according to another aspect of the disclosure also has a terminal that reads the code recorded on the partial receipt, accesses the address of the control server added to the code, and outputs the partial receipt ID added to the code with user identification information managed by the terminal. The control server, when accessed by the terminal, executes a specific process based on the partial receipt ID and user identification information received from the terminal, and information stored relationally to the partial receipt ID.

Thus comprised, the terminal can access the control server by reading the code, and when accessed by the terminal, the control server can execute an appropriate process based on the partial receipt ID and user identification information received from the terminal, and information based on the partial receipt print data.

In a transaction processing system according to another aspect of the disclosure, the specific process executed by the control server is a process of relationally storing the user identification information to information based on the partial receipt print data.

Thus comprised, when accessed by the terminal reading a code, the control server can relationally store the user identification information to information based on the partial receipt print data.

Another aspect of the disclosure is a control method of a recording device, including: receiving partial receipt print data containing a partial receipt ID identifying a partial receipt, which is a receipt issued when a transaction is split between multiple persons; and producing a partial receipt on which a code containing the partial receipt ID is recorded based on the partial receipt print data that was received.

Thus comprised, the disclosure can execute a process appropriate to multiple persons splitting a single bill.

Other objects and attainments together with a fuller understanding of the disclosure will become apparent and appreciated by referring to the following description and claims taken in conjunction with the accompanying drawings.

### BRIEF DESCRIPTION OF THE DRAWINGS

FIG. 1 illustrates the configuration of a transaction processing system according to a preferred embodiment of the disclosure.

FIG. 2 is a block diagram illustrating the functional configuration of devices in the transaction processing system.

FIG. 3 is a flow chart illustrating the operation of devices in the transaction processing system.

FIG. 4 shows an example of a main receipt.

FIG. 5 shows the data structure of a transaction information management database.

FIGS. 6A-6C show an example of a partial receipt.

FIGS. 7A and 7B show another example of the data structure of a transaction information management database.

FIG. 8 shows another example of the data structure of a transaction transaction information management database.

FIG. 9 is a flow chart illustrating the operation of a terminal and the control server.

### DESCRIPTION OF EMBODIMENTS

A preferred embodiment of the present disclosure is described below with reference to the accompanying figures.

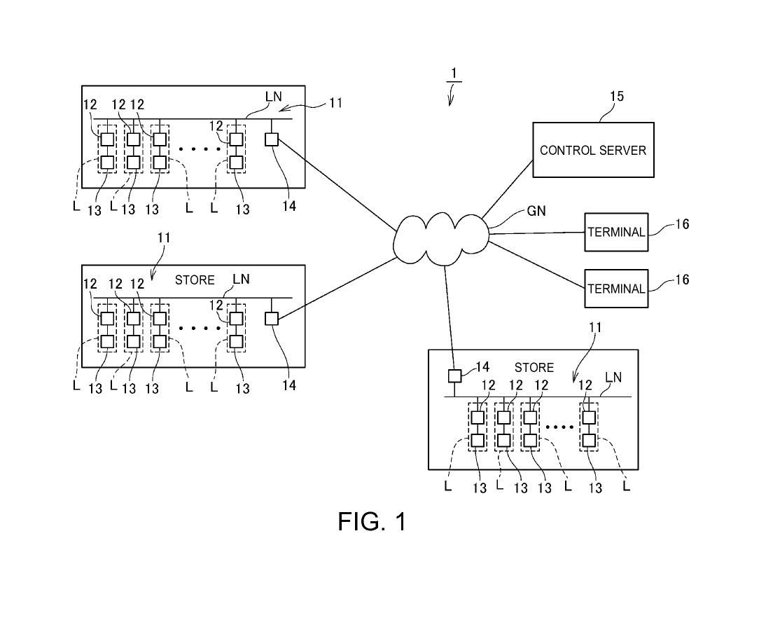

FIG. 1 shows the configuration of a transaction processing system 1 according to a preferred embodiment of the disclosure.

As shown in FIG. 1, the transaction processing system 1 includes a plurality of store systems 11. A store system 11 is a system that is used in retail businesses such as supermarkets, convenience stores, department stores, and restaurants. The store system 11 has functions for processing transactions according to the products purchased by customers, and producing sales (transaction) receipts based on the transactions.

One or more checkout counters L where customer transactions are processed are located in the business. A recording device 12 (recording control device) capable of recording on a recording medium, and a POS terminal 13 that communicates with the recording device 12 and controls the recording device 12, are installed at each checkout counter L.

During a transaction at the checkout counter L, the cash register operator reads barcodes from the products or product packaging using a barcode reader BR connected to the POS terminal 13, and inputs information related to the transaction to the POS terminal 13. Based on input from the barcode reader BR and transaction-related input from the operator, the POS terminal 13 controls the recording device 12 to produce a receipt. The receipt produced by the recording device 12 is then given by the operator to the customer.

The configuration, functions, and processes based on the functions of the recording device 12 and POS terminal 13 are described further below.

A local area network LN is deployed in the store system 11.

The recording device 12 connects to the local area network LN using a communication protocol used on the LAN.

A communication device 14 is also connected to the local area network LN. The communication device 14 is an interface device that connects to the local area network LN and a global network GN (network) such as the Internet . The communication device 14 has the functions of a modem (or ONU (Optical Network Unit)), a router, a DHCP (Dynamic Host Configuration Protocol) server, and a NAT (Network Address Translation) unit. The communication device 14 passes data between devices when a device connected to the local area network LN and a device connected to the global network GN communicate with each other. Note that the communication device 14 is represented by a single function block in FIG. 1, but the communication device 14 may comprise plural devices with different functions.

The recording device 12 can also access the global network GN through the communication device 14.

A control server 15 (information processing device) is connected to the global network GN. The control server 15 is a cloud server in a cloud system in which the recording device 12 is a client. More specifically, when triggered by a request from a client, for example, the control server 15 runs a specific operating process and sends data based on the result of the process to the client. The control server 15 is represented by a single function block in FIG. 1, but this does not mean that the control server 15 is embodied by a single server device. For example, the control server 15 may include a plurality of server devices. More specifically, the control server 15 may be configured in any way enabling executing the processes described below.

A terminal 16 is also connected to the global network GN. The terminal 16 in this example is the tablet-type cell phone (a smartphone) of a customer. The terminal 16 may, however, be any terminal device that can execute the processes described below. For example, a tablet computer may also be used as a terminal 16.

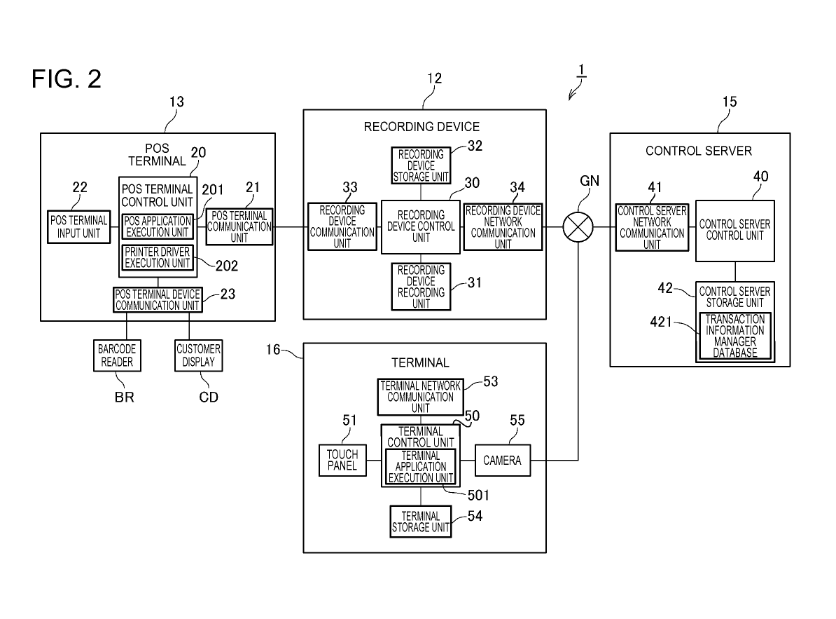

FIG. 2 is a block diagram illustrating the functional configuration of the POS terminal 13, recording device 12, and control server 15.

The POS terminal 13 is a host computer that runs transaction-related processes and controls the recording device 12.

As shown in FIG. 2, the POS terminal 13 includes a POS terminal control unit 20, a POS terminal communication unit 21, a POS terminal input unit 22, and a POS terminal device communication unit 23.

The POS terminal control unit 20 includes a CPU, ROM, RAM, and controls the POS terminal 13. The POS terminal control unit 20 has a POS application execution unit 201 and a printer driver execution unit 202. The function of the POS application execution unit 201 is embodied by the POS terminal control unit 20 reading and running an installed POS application. The function of the printer driver execution unit 202 is embodied by the POS terminal control unit 20 reading and running an installed printer driver. The processes run by these function blocks are described further below.

The POS terminal communication unit 21 communicates with the recording device 12 according to a specific communication protocol as controlled by the POS terminal control unit 20.

The POS terminal input unit 22 has an input means such as a keypad or operating keys, detects input to the input means, and outputs to the POS terminal control unit 20. Based on input from the POS terminal input unit 22, the POS terminal control unit 20 then executes a process appropriate to the input.

The POS terminal device communication unit 23 is an interface board with a USB port, a serial communication port other than a USB port, or other types of communication ports. Various devices can connect to the different ports. The POS terminal device communication unit 23 communicates with devices connected to the POS terminal 13 through the appropriate ports as controlled by the POS terminal control unit 20.

Note that the POS terminal device communication unit 23 may also have a wireless communication port and communicate with other devices wirelessly.

A barcode reader BR and customer display CD are examples of devices connected to the POS terminal 13 in this example.

The barcode reader BR is used to read barcodes from products and product packaging, and outputs data representing the read barcodes to the POS terminal device communication unit 23. The POS terminal device communication unit 23 then outputs the data input from the barcode reader BR to the POS terminal control unit 20.

The customer display CD displays transaction-related information as controlled by the POS terminal control unit 20. The information presented on the customer display CD can be read by the customer involved in the transaction at the checkout counter L.

The recording device 12 is a thermal line printer that holds roll paper and forms dots on the stored roll paper with a line thermal head to record images.

As shown in FIG. 2, the recording device 12 has a recording device control unit 30 (control unit), a recording device recording unit 31 (recording unit), a recording device storage unit 32, a recording device communication unit 33, and a recording device network communication unit 34.

The recording device control unit 30 includes a CPU, ROM, RAM, and other peripheral circuits, and controls the recording device 12.

The recording device recording unit 31 includes mechanisms related to recording on roll paper, such as a conveyance mechanism for conveying roll paper stored inside the cabinet of the recording device 12, a recording mechanism for forming dots and recording images on the roll paper with a thermal head, and a cutter mechanism for cutting the roll paper at a specific position. The recording device recording unit 31 records receipt-related images on the roll paper by the recording mechanism while conveying the roll paper with the conveyance mechanism, and then cuts the roll paper at a specific position with the cutter mechanism, producing a receipt.

The recording device storage unit 32 has nonvolatile memory and stores data.

The recording device communication unit 33 communicates with the POS terminal 13 according to a specific communication protocol as controlled by the recording device control unit 30.

The recording device network communication unit 34 communicates with devices connected to the global network GN (including the control server 15) according to a specific communication protocol as controlled by the recording device control unit 30.

The control server 15 is a cloud server to which the recording device 12 connects as a client.

As shown in FIG. 2, the control server 15 includes a control server control unit 40 (control unit), control server network communication unit 41, and control server storage unit 42.

The control server control unit 40 includes a CPU, ROM, RAM, and other peripheral circuits, and controls the control server 15.

The control server network communication unit 41 communicates with devices connected to the global network GN (including recording devices 12) according to a specific communication protocol as controlled by the control server control unit 40.

The control server storage unit 42 includes nonvolatile memory, and stores data. The data stored by the control server storage unit 42 is described further below.

As shown in FIG. 2, the terminal 16 has a terminal control unit 50, a touch panel 51, a terminal network communication unit 53, a terminal storage unit 54, and a camera 55.

The terminal control unit 50 includes a CPU, ROM, RAM, and other peripheral circuits, and controls the terminal 16.

The touch panel 51 includes a display panel on the front of the terminal 16, and a touch sensor disposed over the display panel. The display panel may be a LCD panel, OLED panel, or other type of display. The touch sensor is a capacitive or pressure sensitive sensor, detects touch operations by the user's fingers or a stylus, for example, and outputs to the terminal control unit 50.

The terminal network communication unit 53 communicates through the global network GN with other devices (including the control server 15) connected to the network according to a specific communication protocol as controlled by the terminal control unit 50.

The camera 55 includes an imaging element such as a CCD image sensor or a CMOS image sensor, a photographic lens group, and a lens drive unit that drives the photographic lens group to adjust the zoom or focus, for example, and is used to take pictures. The camera 55 generates picture image data from the captured image, and outputs to the terminal control unit 50.

The terminal storage unit 54 includes nonvolatile memory and stores data.

A specific application (referred to below as the terminal application AP) is previously installed to the terminal 16. The terminal control unit 50 of the terminal 16 includes a terminal application execution unit 501 that executes processes through functions of the terminal application AP. The processes of the terminal application execution unit 501 are described further below.

When a transaction is processed at the checkout counter L, payment for the transaction may be split between multiple persons. When payment is thus split between multiple persons, the POS terminal 13, recording device 12, and control server 15 in this embodiment of the disclosure execute the process described below.

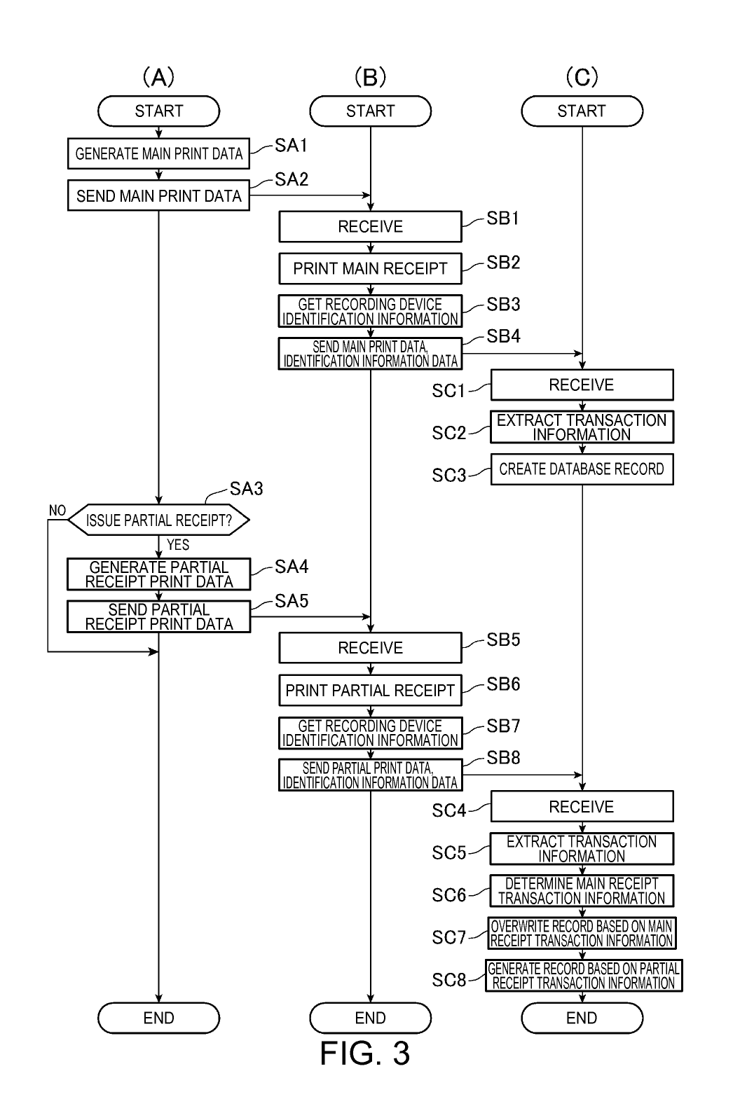

FIG. 3 is a flow chart of the operation of the POS terminal 13, recording device 12, and control server 15, column (A) of FIG. 3 showing the operation of the POS terminal 13, column (B) of FIG. 3 showing the operation of the recording device 12, and column (C) of FIG. 3 showing the operation of the control server 15.

As shown in column (A) of FIG. 3, the POS terminal control unit 20 of the POS terminal 13 executes a payment process according to the customer transaction, and generates print data based on the payment process (step SA1). The print data is control data for producing a receipt.

More specifically, in step SA1, the POS application execution unit 201 of the POS terminal control unit 20 generates receipt information based on the customer transaction. The receipt information is information the recording device 12 records on the produced receipt.

Next, the POS application execution unit 201 outputs the generated receipt information to the printer driver execution unit 202.

The printer driver execution unit 202 generates print data based on the receipt information input from the POS application execution unit 201. The print data is control data instructing producing a receipt with the receipt information recorded in a specific format, and includes plural control commands in the command language of the recording device

The print data generated by the POS terminal 13 in step SA1 is referred to below as the main print data, and is distinguished from the partial receipt print data described further below. The main print data is print data for producing a receipt for a single payer, that is, a payment that is not split between multiple persons.

After generating the print data, the POS terminal control unit 20 controls the POS terminal communication unit 21 to send the resulting main print data to the recording device 12 (step SA2).

As shown in column (B) of FIG. 3, the recording device control unit 30 of the recording device 12 controls the recording device communication unit 33 to receive the main print data (step SB1).

Next, the recording device control unit 30 controls the recording device recording unit 31 based on the main print data that was received to produce a receipt (step SB2). The process of step SB2 and the resulting receipt are described further below.

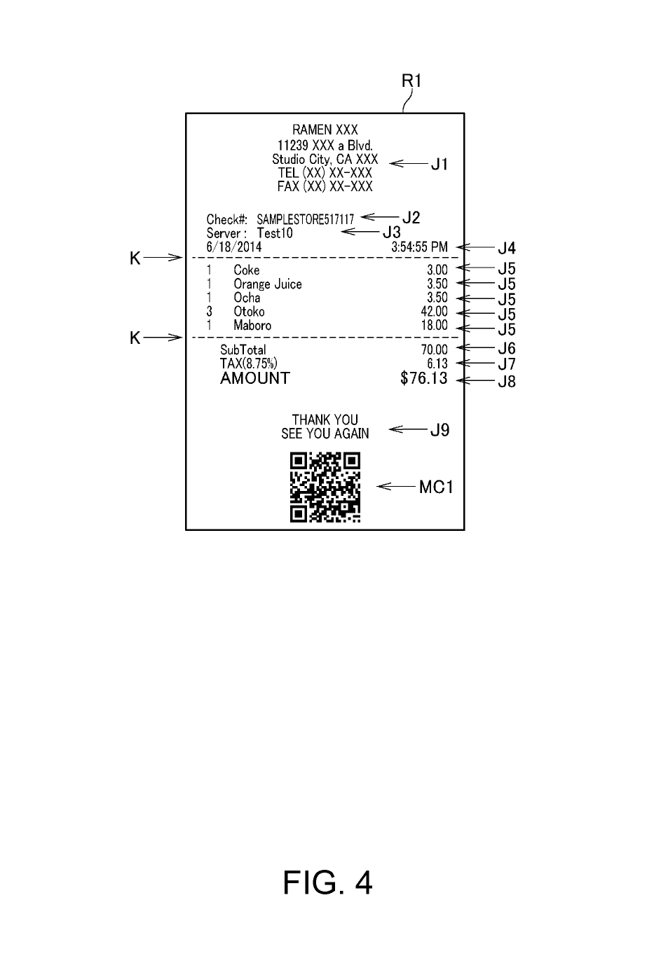

A receipt produced by the recording device 12 in step SB2 is referred to below as a main receipt, which is different from a partial receipt as described below. A main receipt is a receipt that is produced based on the main print data and does not reflect a split payment. The receipt R1 shown in FIG. 4 is an example of a main receipt.

FIG. 4 shows an example of a receipt R1.

Information such as the name, address, telephone number, or fax number of the store, referred to as store information J1 below, is recorded on the receipt R1 in the example shown in FIG. 4.

Also recorded on the receipt R1 is receipt identification information J2 including a receipt ID that identifies a specific receipt.

Also recorded on the receipt R1 is register operator identification information J3 (also referred to below operator information) including information such as the name of the operator of the register at the checkout counter L where the transaction is completed. The register operator identification information J3 is registered by a specific means in the POS terminal 13 before the transaction starts.

Also recorded on the receipt R1 is receipt date information J4 (also referred to below as needed as date information) including information indicating when the receipt is produced.

One or more lines of line item information J5 (also referred to below as needed as purchased product information) related to the products the customer purchases is also recorded on the receipt R1. The line item information J5 includes for each item the customer purchases information indicating the quantity (purchase quantity information) of the product on that line, information indicating the name of the product (product name information), and information indicating the unit price of the product (unit price information).

Subtotal information J6 (also referred to below as needed as subtotal information) including information indicating the subtotal is recorded on the receipt R1.

Also recorded on the receipt R1 is tax-related information J7 (also referred to below as needed as tax information) including information about the applicable taxes.

Also recorded on the receipt R1 is transaction total information J8 (also referred to below as needed as total amount information) including information indicating the transaction total.

Also recorded on the receipt R1 is message information J9 containing a specific message for the customer.

Delimiter information K that delimits parts of the receipt R1 is also recorded on the receipt R1 between the receipt date information J4 and the first line of line item information J5, and between the last line of line item information J5 and the subtotal information J6.

The receipt information in this sample receipt R1 includes the store information J1 to the message information J9, and the two delimiter information K lines.

A receipt ID that identifies a main receipt is referred to below as the main receipt ID, and a receipt ID that identifies a partial receipt is referred to below as a partial receipt ID.

A main receipt code, which in this embodiment is a 2D code symbol, is recorded on the main receipt. A main receipt code MC1, which is a 2D code symbol, is recorded to the receipt R1 in the example shown in FIG. 4. The main receipt code MC1 is a 2D code including information adding the main receipt ID as a URL query parameter to the specific URL (address) of the control server 15.

The specific URL of the control server 15 is referred to below as the control server URL.

In step SB2, the recording device control unit 30 then records receipt information in a specific format based on the main print data. The recording device control unit 30 also reads the control server URL from a predetermined storage area, and adds the main receipt ID to the URL query parameter. The recording device control unit 30 also generates image data for a 2D code including the control server URL, and based on the generated image data records the main receipt code on the roll paper.

In step SB2, the printed main receipt is given by the cash register operator to the customer. However, if partial receipts are printed, the partial receipts are given to the customers instead of the main receipt.

After printing a main receipt, the recording device control unit 30 gets the recording device identification information (step SB3). The recording device identification information is identification information identifying the recording device 12, and different recording device identification information is assigned to each recording device 12. For example, the recording device identification information may be the serial number assigned to the recording device 12 when the recording device 12 is manufactured. The recording device identification information is stored in a specific storage area of the recording device storage unit 32, and in step SB3 the recording device control unit 30 reads the recording device identification information from the specific storage area.

Next, the recording device control unit 30 controls the recording device network communication unit 34 to send the main print data and identification information data representing the recording device identification information to the control server 15 (step SB4).

As shown in column (C) of FIG. 3, the control server control unit 40 of the control server 15 controls the control server network communication unit 41 to receive the main print data and identification information data (step SC1).

Next, the control server control unit 40 extracts the transaction information from the received main print data (step SC2). The transaction information is a specific subset of the information recorded on the receipt. In the receipt R1 shown in FIG. 4 for example in this embodiment of the disclosure, the transaction information includes the business information, receipt ID, cash register operator information, receipt date information, purchased product information (purchase quantity information, product name information, unit price information), subtotal information, tax information, and total amount information.

Next, the control server control unit 40 accesses the transaction information manager database 421 stored by the control server storage unit 42 and creates a record based on the transaction information extracted in step SC2 (step SC3).

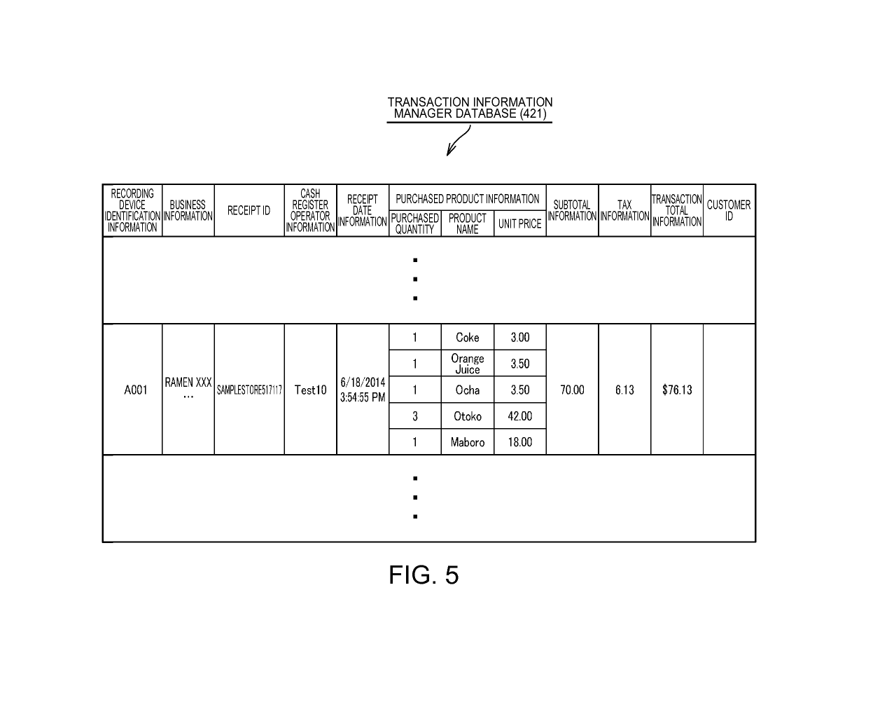

FIG. 5 illustrates the data structure of the transaction information manager database 421.

As shown in FIG. 5, one record in the transaction information manager database 421 contains recording device identification information and transaction information. The transaction information includes business information, receipt ID, operator information, receipt date information, purchased product information (purchase quantity information, product name information, unit price information), subtotal information, tax information, and total amount information.

In step SC3, the control server control unit 40 creates one record in the transaction information manager database 421, and stores the recording device identification information denoted by the identification information data received in step SC1 in the corresponding field of the created record. The control server control unit 40 also stores the transaction information extracted in step SC2 in the corresponding fields of the created record.

Note that record RC1 in FIG. 5 shows an example of the record created based on the main print data used to print the receipt R1 in FIG. 4.

As shown in column (A) of FIG. 3, after sending the main print data, the POS terminal control unit 20 of the POS terminal 13 determines whether or not to print a partial receipt (step SA3).

A partial receipt is described first below, and the process of step SA3 is then described.

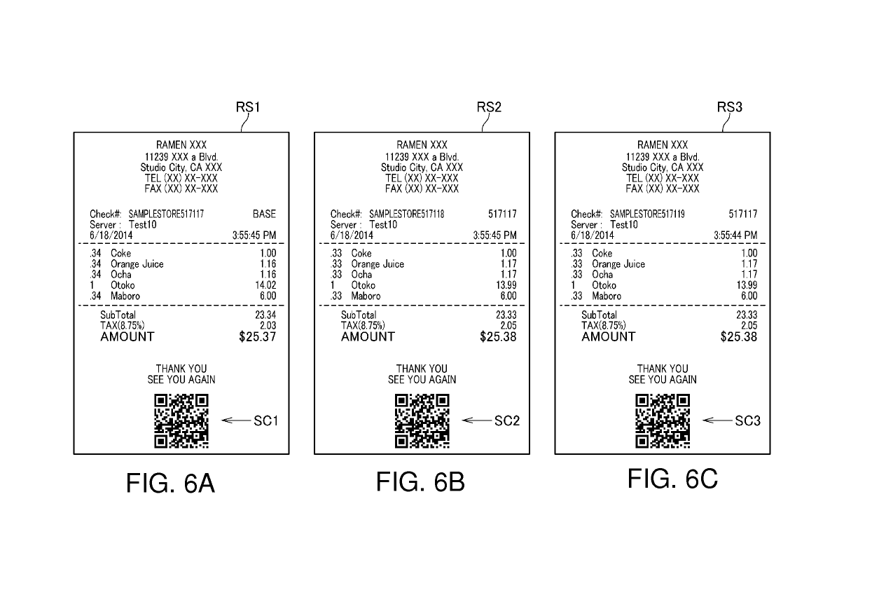

FIGS . 6A-6C show examples of the partial receipts that are produced when the bill is split between three people after producing the main receipt shown in FIG. 4. FIG. 6A shows an example of a receipt RS1 that is one example of a partial receipt, FIG. 6B shows an example of a receipt RS2 that is another example of a partial receipt, and FIG. 6C shows an example of a receipt RS3 that is another example of a partial receipt.

As will be obvious from comparing the samples shown in FIG. 4 and FIGS. 6A-6C, a partial receipt is a receipt printed with the amounts of the purchase quantity information, unit price information, subtotal information, tax information, and total amount information in the main receipt divided by the number of people that are splitting the bill.

For example, the value of the purchase quantity information in the line item information J5 on the first line of the receipt R1 (main receipt) shown in FIG. 4 is 1, and the value of the unit price information is 3.00. In this event, as shown in FIGS. 6A-6C, the value of the purchase quantity information in the partial receipt that is printed is the value (1) of the print quantity in the receipt R1 divided by the number of people (3) sharing the bill. The value of the total amount of the partial receipt that is printed is the value of the unit price information (3.00) on the main receipt R1 divided by the number of people (3). Note that if the value of any information on the main receipt cannot be evenly divided by the number of people, the values are adjusted by a predetermined method.

Note that a main receipt and partial receipt are related to each other means that the main receipt and the partial receipts are issued for a common single transaction.

Because payment is received from more than one person when the bill is split, the same number of partial receipts are printed as people paying. More specifically, plural partial receipts are printed.

There are also plural types of partial receipts, referred to below as parent partial receipts and child partial receipts. Of the plural printed partial receipts, one partial receipt is considered the parent partial receipt, and the other partial receipts are child partial receipts. For example, when three partial receipts are printed for three people splitting the bill, one of the three partial receipts is the parent partial receipt and the other two partial receipts are child partial receipts.

In the example shown in FIGS. 6A-6C, the receipt RS1 in FIG. 6A is the parent partial receipt, the receipt RS2 in FIG. 6B is a child partial receipt, and the receipt RS3 in FIG. 6C is also a child partial receipt.

In this embodiment of the disclosure, the receipt IDs of the main receipt and the related parent partial receipt are related as described below, and the receipt IDs of the parent partial receipt and the child partial receipts are related as described below.

Below, the receipt ID of the main receipt is called the main receipt ID, and the receipt ID of a partial receipt is called the partial receipt ID. The partial receipt ID of the parent partial receipt is called the parent partial receipt ID, and the partial receipt ID of a child partial receipt is called a child partial receipt ID.

The value of the main receipt ID of the main receipt shown for example in FIG. 4 is the string SAMPLESTORE517117. As shown in this example, the main receipt ID has an alphabetic portion (the string SAMPLESTORE in the example in FIG. 4) comprising a continuous string of alphabetic characters, followed by a numeric portion (the numeric string 517117 in the example in FIG. 4) comprising a continuous string of numbers following the alphabetic portion with no space therebetween.

The value of the parent partial receipt ID of the parent partial receipt shown in the example in FIG. 6A is the string SAMPLESTORE517117_ . . . _BASE″ (where_ . . . _denotes plural consecutive white spaces). The value of the parent partial receipt ID thus includes a parent partial receipt ID portion, which is the value of the main receipt ID of the corresponding main receipt (the portion corresponding to the string SAMPLESTORE517117 in the example in FIG. 6A), plural white spaces, and the string BASE.

Whether or not a receipt is a parent partial receipt can therefore be determined by checking if the string BASE is included in the receipt ID. The receipt ID of the matching main receipt (the main receipt ID) can also be acquired from a partial receipt from the parent partial receipt ID portion of the parent partial receipt ID.

The value of the child partial receipt ID of the child partial receipt shown in FIG. 6B is the string SAMPLESTORE517118_ . . . _517117.

The value of the child partial receipt ID of the child partial receipt shown in FIG. 6C is the string SAMPLESTORE517119_ . . . _517117.

The value of the child partial receipt ID thus includes a child partial receipt ID portion (corresponding to the string SAMPLESTORE517118 in the example in FIG. 6B, and the string SAMPLESTORE517119 in the example in FIG. 6C), plural white spaces, and a related identification information portion (the string 517117 in the examples shown in FIGS. 6B and 6C).

The value of the child partial receipt ID is the sum of the value of the parent partial receipt ID of the parent partial receipt (that is, the value of the main receipt ID of the corresponding main receipt) plus 1 based on the number of child partial receipts that are issued. For example, if two child partial receipts are issued as in this example, the value of the child partial receipt ID of receipt RS2, which is the first child partial receipt shown in FIG. 6B, is the value of the parent partial receipt ID of the parent partial receipt (that is, the value of the main receipt ID of the corresponding main receipt) plus 1. The value of the child partial receipt ID of receipt RS3, which is the second child partial receipt shown in FIG. 6C, is the value of the child partial receipt ID of the first partial receipt R1 plus 1.

The value of the related identification information portion is the value (that is, the value of the numeric portion of the main receipt ID of the corresponding main receipt) of the numeric portion of the parent partial receipt ID of the parent partial receipt.

A subcode is recorded on each partial receipt. The subcode is described below.

In step SA3, the POS terminal control unit 20 determines whether or not to issue partial receipts. The decision process is described below.

Using a specific input means of the POS terminal 13, the cash register operator can input a command to print partial receipts for a split bill, and the number of people splitting the bill. The operator inputs the command to print partial receipts and the number of people splitting the bill using the specific input means in response to a request from the customer.

In step SA3, the POS terminal control unit 20 decides to print partial receipts when the operator inputs the command to print partial receipts and the number of people splitting the bill within a specific time after printing the main receipt. This specific time may be preset in advance, or the period until the next transaction is started. The next transaction may be started, for example, when a new barcode is read with the barcode reader BR.

If a partial receipt is not issued (step SA3 returns NO), the POS terminal control unit 20 ends the process.

If partial receipts are issued (step SA3 returns YES), the POS terminal control unit 20 generates print data (partial receipt print data) instructing printing a partial receipt for each partial receipt to print based on the number of people paying (step SA4).

In step SA4, the POS terminal control unit 20 generates partial receipt print data for each partial receipt to print. As described above, the value of the partial receipt ID (parent partial receipt ID and child partial receipts ID) specified in the partial receipt print data for recording is a value with a specific relationship to the value of the main receipt ID. The values of the purchase quantity information, unit price information, subtotal information, tax information, and total amount information in the print data for each partial receipt are the values of the same items in the related main receipt divided by the number of people splitting the bill.

Next, the POS terminal control unit 20 controls the POS terminal communication unit 21 to send the print data for the plural partial receipts to the recording device 12 (step SA5).

As shown in column (B) of FIG. 3, the recording device control unit 30 of the recording device 12 controls the recording device communication unit 33 to receive the print data for the plural partial receipts (step SB5).

Next, the recording device control unit 30 controls the recording device recording unit 31 to print the plural partial receipts based on the print data received for the plural partial receipts (step SB6).

The recording device control unit 30 records a subcode, which is a 2D code symbol, on each partial receipt . Subcode SC1 is recorded on the receipt RS1 shown in FIG. 6A, subcode SC2 is recorded on the receipt RS2 shown in FIG. 6B, and subcode SC3 is recorded on the receipt RS3 shown in FIG. 6C.

The subcode is a 2D code including information adding the partial receipt ID as a URL query parameter to the control server URL described above. For example, the subcode SC1 recorded on receipt RS1 has information adding the partial receipt ID identifying the receipt RS1 as a URL query parameter to the control server URL.

In step SB6, the recording device control unit 30 generates image data for a 2D code including the control server URL based on the print data for each partial receipt, and records the subcode on the roll paper based on the generated image data.

The plural printed partial receipts are then given to each of the people paying the bill instead of the main receipt. In other words, when partial receipts are produced, the partial receipts are given to the customers instead of the main receipt.

Next, the recording device control unit 30 gets the recording device identification information (step SB7).

Next, the recording device control unit 30 controls the recording device network communication unit 34 to send the print data for the plural partial receipts together with the identification information data denoting the recording device identification information (step SB8).

As shown in column (C) of FIG. 3, the control server control unit 40 of the control server 15 controls the control server network communication unit 41 to receive the print data for the plural partial receipts (step SC4).

Next, the control server control unit 40 extracts the transaction information from the partial receipt print data (step SC5).

Below, the transaction information extracted from the partial receipt print data for printing the parent partial receipt is referred to as the parent transaction information, and the transaction information extracted from the partial receipt print data for printing a child partial receipt is referred to as child transaction information.

Next, the control server control unit 40 identifies the parent transaction information in the transaction information extracted in step SC5 from the print data generated for each partial receipt (step SC6). The transaction information includes the receipt ID as described above. The receipt ID of the partial receipt print data for printing the parent partial receipt (that is, the parent partial receipt ID) also contains the string BASE. As a result, in step SC6, the control server control unit 40 can find the parent transaction information by a string search for the string BASE to find the transaction information containing the string BASE in the receipt ID.

Next, the control server control unit 40 accesses the transaction information manager database 421 and based on the parent transaction information identified in step SC7, overwrites the record generated in step SC3 (the record generated based on the main print data instructing printing the corresponding main receipt) (step SC7).

More specifically in step SC7, the control server control unit 40 gets the value of the parent partial receipt ID part of the receipt ID (parent partial receipt ID) contained in the parent transaction information identified in step SC6. As described above, the value of the parent partial receipt ID portion matches the receipt ID of the corresponding main receipt (the main receipt ID). Next, the control server control unit 40 accesses the transaction information manager database 421, and acquires from the records in the database the record with a receipt ID that matches the value of the parent partial receipt ID that was acquired. Next, the control server control unit 40 overwrites the located record with a record based on the detected parent transaction information in step SC7.

As a result, the record based on the main print data for the main receipt is deleted from the transaction information manager database 421, and a new record based on the partial receipt print data for the parent partial receipt is stored in the database.

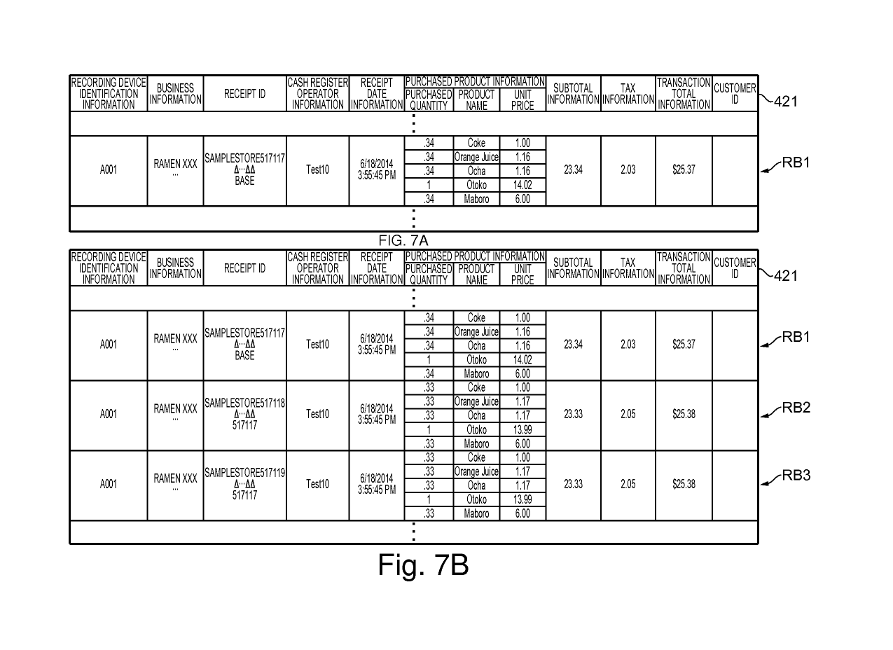

FIG. 7A shows the result of overwriting the record RC1 in FIG. 5 with a record RB1 based on the partial receipt print data for receipt RS1 (the parent partial receipt) in step SC7.

Next, the control server control unit 40 accesses the transaction information manager database 421 and creates a new record for the child transaction information acquired in step SC5 for each of the one or more child receipts (step SC8).

As a result, a record is saved in the transaction information manager database 421 for each partial receipt that is produced.

FIG. 7B shows the result of creating and storing record RB2 and record RB3 based on partial receipt print data for receipt RS2 (child partial receipt) and receipt RS3 (child partial receipt) in the transaction information manager database 421 in step SC8.

As described above, the control server control unit 40 in this embodiment of the disclosure creates records based on the transaction information for a main receipt in the transaction information manager database 421 when a main receipt is produced. When partial receipts are produced, the control server control unit 40 overwrites the record for the main receipt with a record for a parent partial receipt, and creates a record for each partial receipt that is printed in the transaction information manager database 421.

The effect of this is described below.

Specifically, the transaction information manager database 421 may later be used, for example, to analyze sales per store during a specific period of time, sales at a specific checkout counter L, sales of a specific product, and other transaction related information.

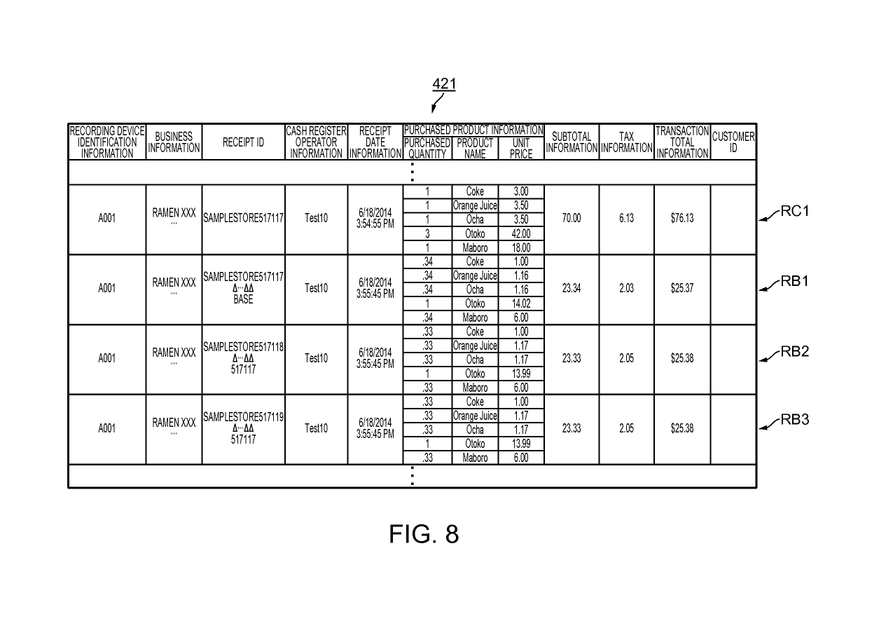

FIG. 8 shows an example of the transaction information manager database 421 when the record of the main receipt is not overwritten with a record related to the parent partial receipt when partial receipts are issued.

As shown in FIG. 8, when both the main receipt record and partial receipt records are stored in the transaction information manager database 421, duplicate records will be recorded for the same transaction. When tabulating and analyzing sales in this event, data will be tabulated based on the sales recorded in the main receipt and sales recorded in the partial receipts, and incorrect results may be computed. The same thing will happen when tabulating and analyzing the total sales of a specific product.

However, because a main receipt record and records for partial receipts are not both stored in the transaction information manager database 421 in this embodiment of the disclosure, such sales tabulation and computation errors, for example, can be prevented.

The process of the terminal 16 and the control server 15 when a customer that split a bill uses the customer's own terminal 16 to read the subcode from the partial receipt the customer received is described next.

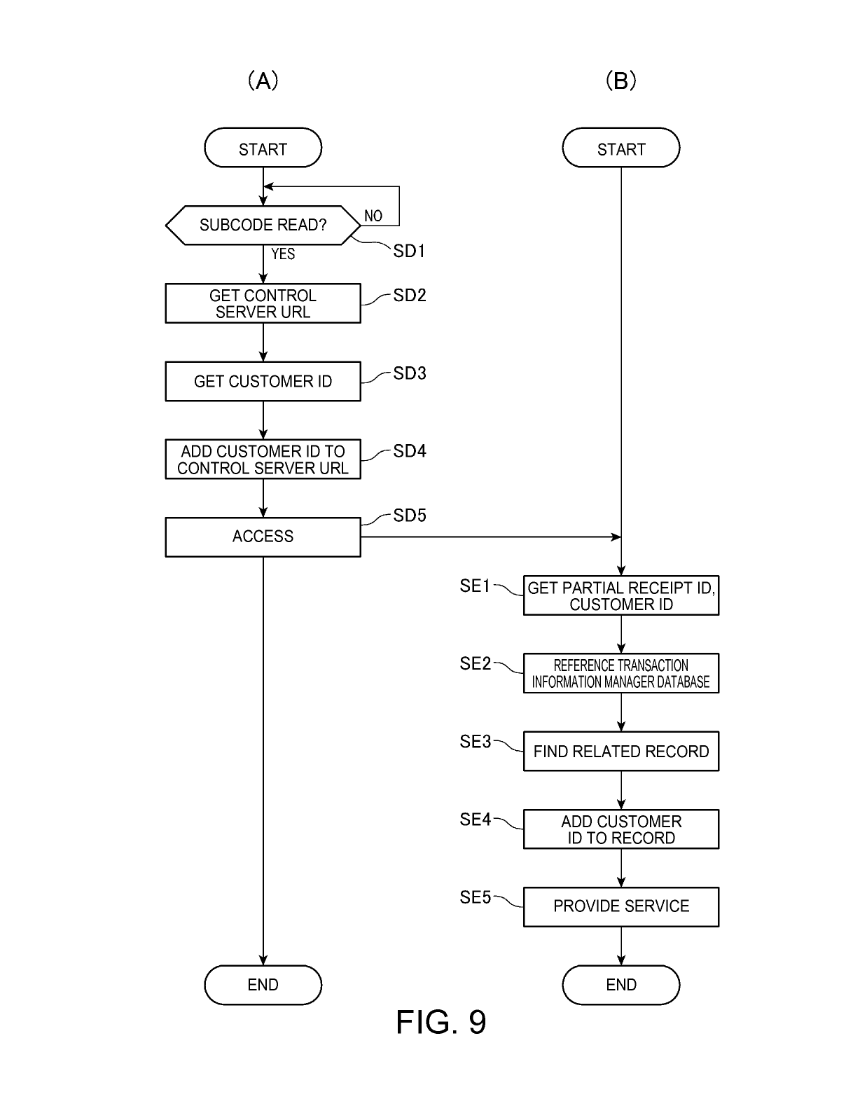

FIG. 9 is a flowchart illustrating the operation of the terminal 16 and the control server 15, column (A) of FIG. 9 showing the operation of the terminal 16 and column (B) of FIG. 9 showing the operation of the control server 15.

As shown in column (A) of FIG. 9, the terminal application execution unit 501 of the terminal 16 analyzes the picture image data input from the camera 55 to determine whether or not the image data of a 2D code symbol is in the picture image data (step SD1).

The operation described below begins when the customer has read (imaged) the subcode with the terminal 16.

When a 2D code is detected (step SD1 returns YES), the terminal application execution unit 501 analyzes the image data of the 2D code contained in the captured image data, and determines the control server URL contained in the 2D code (step SD2). As described above, the partial receipt ID of the partial receipt given to the customer is added to the control server URL as a URL query parameter.

Next, the terminal application execution unit 501 gets the customer ID (user identification information) (step SD3). The customer ID is identification information is previously assigned to each user with access to services from the control server 15, and is previously stored in a specific storage area accessible to the terminal application execution unit 501.

Next, the terminal application execution unit 501 adds the customer ID acquired in step SD3 as a URL query parameter to the control server URL acquired in step SD2 (step SD4). As a result, the partial receipt ID and customer ID are added to the control server URL as URL query parameters.

Next, the terminal application execution unit 501 accesses the control server URL (step SD5).

The process of step SD5 is equivalent to the terminal 16 sending the partial receipt ID added to the subcode (code) and the customer ID (user identification information) managed by the terminal 16 to the control server 15.

As shown in column (B) of FIG. 9, the control server control unit 40 of the control server 15 retrieves the partial receipt ID added as a URL query parameter, and the customer ID, in response to the terminal 16 accessing the control server URL (step SE1).

Next, the control server control unit 40 references the transaction information manager database 421 (step SE2).

Next, using the partial receipt ID acquired in step SE1 as the search key, the control server control unit 40 searches the records of the transaction information manager database 421 to find the record storing the partial receipt ID acquired in step SE1 as the receipt ID (step SE3).

Next, the control server control unit 40 adds the customer ID acquired in step SE1 to the located record (step SE4). More specifically, the control server control unit 40 relationally stores the transaction information of the partial receipt (partial receipt print data) to the customer ID.

Each record in the transaction information manager database 421 has a field for storing a customer ID. In step SE4, the control server control unit 40 adds the customer ID to the record found in step SE1 by storing the customer ID in the appropriate field.

Next, the control server control unit 40 provides a service to the customer based on the record generated in step SE5 in the transaction information manager database 421 (step SE5).

In this example, the provided service is awarding point. An example of a process of awarding points is described next.

In this example, the control server storage unit 42 of the control server 15 stores a database that relationally stores the customer ID to the remaining balance of points awarded to the customer. The number of points awarded is predetermined according to the total purchase amount of the transaction. Based on the transaction information, the control server control unit 40 gets the total amount of the transaction, and decides how many points to award based on the acquired total purchase amount. Next, the control server control unit 40 accesses the above database, finds the corresponding recording using the customer ID as the search key, and increases the balance of points stored in the located record based on the number of points to award.

When a bill is split between multiple persons in this embodiment of the disclosure, a partial receipt is issued for each person that split the bill and given to each person. The control server 15 also generates a record containing transaction information for each partial receipt in the transaction information manager database 421.

When a customer that split a bill then reads the subcode recorded on the partial receipt given to that customer, the control server 15 provides a service (awarding points in this example) to the customer based on the transaction information for that partial receipt. This enables even customers that split a bill to receive a service appropriate to the payment that customer made when splitting the bill.

More specifically, each person that paid part of a bill can receive a service appropriate to the customer's portion of the bill, customers will not feel slighted, and customer satisfaction can be improved.

The service provided by the control server 15 is not limited to the foregoing example. Because the customer ID and transaction information are relationally stored in step SE4, various services can be provided using this information. For example, electronic receipts can be issued, and coupons, advertising, and market promotions can be provided based on the products purchased in a transaction.

Furthermore, because the customer ID and transaction information are relationally stored in step SE4, transactions of individual customers can be analyzed, and services based on the results of the analysis can be provided.

As described above, a transaction processing system 1 according to this embodiment includes a POS terminal 13, a recording device 12 with a recording device recording unit 31 (recording unit) that records on recording media, and a control server 15 that communicates with the recording device 12 through a global network GN.

The POS terminal 13 generates and sends partial receipt print data to the recording device 12.

The recording device 12 receives the partial receipt print data from the POS terminal 13, and based on the received partial receipt print data, controls the recording device recording unit 31 to produce a partial receipt on which are recorded a partial receipt ID and a subcode (code) to which the URL (address) of the control server 15 was added. The recording device 12 then sends the partial receipt print data to the control server 15.

The control server 15 relationally stores the transaction (information) based on the partial receipt print data received from the recording device 12 with the partial receipt ID contained in the partial receipt print data.

Thus comprised, when the subcode recorded on a partial receipt is read and the control server 15 is accessed, the control server 15 locates the corresponding transaction information (a record in the transaction information manager database 421) based on the partial receipt ID, and can provide services appropriate to transaction information about a split bill based on the transaction information (database record) that is found. In other words, the transaction processing system 1 can execute processes appropriate to split bills.

When the control server 15 is accessed based on the terminal 16 reading a subcode in this example, the control server 15 executes a specific process based on the partial receipt ID and customer ID (user identification information) acquired in the access request, and the transaction information relationally stored to the partial receipt ID.

Thus comprised, for each person involved in a transaction, the control server 15 can execute a process that uses transaction information based on the customer's transaction.

The control server 15 in this embodiment of the disclosure also relationally stores the customer ID to transaction information based on the partial receipt print data.

Thus comprised, the control server 15 can relationally manage customer IDs and transaction information, and provide to the customer of a specific customer ID services appropriate to that customer's transactions.

The disclosure is described above with reference to a preferred embodiment thereof, but the disclosure is not limited thereto and can be modified and adapted in many ways without departing from the scope of the accompanying claims.

Receipt R1 and receipts RS1 to RS3 are used as examples of receipts in the foregoing embodiment and processes of the disclosure are described with reference to these sample receipts. The layouts of the receipts are not limited to the foregoing examples, however, and the transaction information extracted from the receipts is not limited to the foregoing.

“Information based on partial receipt print data” is transaction information in the foregoing example, but may be the partial receipt print data itself.

The disclosure being thus described, it will be obvious that it may be varied in many ways. Such variations are not to be regarded as a departure from the spirit and scope of the disclosure, and all such modifications as would be obvious to one skilled in the art are intended to be included within the scope of the following claims.

What is claimed is:

1. A recording device comprising:
a recording unit that records on recording media;
a communication unit that receives data for the recording unit to print; and
a control unit that causes the communication unit to receive partial receipt print data containing a partial receipt ID identifying a partial receipt, which is a receipt issued when a transaction is split between multiple persons, and
causes the recording unit to produce a partial receipt on which a code containing the partial receipt ID is recorded based on the partial receipt print data the communication unit received.

2. The recording device described in claim 1, wherein:
the communication unit causes the recording unit to produce a partial receipt on which a code containing the partial receipt ID and the address of an external device is recorded.

3. A transaction processing system comprising:
a POS terminal;
a recording device that communicates with the POS terminal and has a recording unit that records on recording media; and
a control server that connects to the recording device through a network;
the POS terminal generating and sending partial receipt print data to the recording device, the partial receipt print data instructing producing a partial receipt, which is a receipt issued when a transaction is split between multiple persons, and containing a partial receipt ID identifying the partial receipt;
the recording device receiving the partial receipt print data from the POS terminal, causing the recording unit to produce a partial receipt on which a code containing the partial receipt ID and the address of the control server is recorded based on the received partial receipt print data, and sending the partial receipt print data to the control server; and
the control server storing information based on the partial receipt print data received from the recording device relationally to the partial receipt ID contained in the partial receipt print data.

4. The transaction processing system described in claim 3, further comprising:
a terminal that reads the code recorded on the partial receipt, accesses the address of the control server added to the code, and outputs the partial receipt ID added to the code with user identification information managed by the terminal;
the control server, when accessed by the terminal, executing a specific process based on the partial receipt ID and user identification information received from the terminal, and information stored relationally to the partial receipt ID.

5. The transaction processing system described in claim 4, wherein:
the specific process executed by the control server is a process of relationally storing the user identification information to information based on the partial receipt print data.

6. A control method of a recording device, comprising:
receiving partial receipt print data containing a partial receipt ID identifying a partial receipt, which is a receipt issued when a transaction is split between multiple persons; and
producing a partial receipt on which a code containing the partial receipt ID is recorded based on the partial receipt print data that was received.

7. The control method of a recording device described in claim 6, further comprising:
producing a partial receipt on which a code containing the partial receipt ID and the address of an external device is recorded.
